(19) United States
(12) Patent Application Publication
(10) Pub. No.: US 2012/0185798 A1
(43) Pub. Date: Jul. 19, 2012

(54) APPLICATION VIEW REGION

(76) Inventors: John O. Louch, San Luis Obispo, CA (US); Timothy W. Bumgarner, Sharpsburg, MD (US); Christopher J. Hynes, Mountain View, CA (US)

(21) Appl. No.: 13/094,791

(22) Filed: Apr. 26, 2011

Related U.S. Application Data
(60) Provisional application No. 61/433,125, filed on Jan. 14, 2011.

(51) Int. Cl. G06F 3/048

(52) U.S. Cl. 715/796

(57) ABSTRACT

A minimized view of an application is provided, in one embodiment, from an application or window control region. The minimized view of a first application can include controls (e.g., commands such as a play button or command and a pause button or command) that are available when a first window of the first application is the front most window. The minimized view can be invoked and receive and respond to user inputs on the controls even when a second application's window is the front most window.

This application claims the benefit of the filing date, under 35 U.S.C. §119(e), of U.S. Provisional Application No. 61/433,125 filed on Jan. 14, 2011.

### BACKGROUND OF THE INVENTION

Data processing systems, such as a general purpose computer or other types of electronic devices, often employ a graphical user interface which allows for the simultaneous presentation of multiple windows which can at least partially overlap each other on the screen of a display device. FIG. 1A of published U.S. Application No. 2010/0313164 shows an example of a graphical user interface on a screen of a display device; there are multiple overlapping windows, often presented by multiple applications which are different applications and which are running concurrently on the data processing system. While the ability to have multiple windows open concurrently can provide a rich operating environment, thereby allowing a user to view and operate on windows from multiple, different applications, it can also create confusion and clutter in the graphical user interface. A window control region provides one way to allow some control of the different windows by being able to select individually or as a group the various windows to cause them to be presented in the foreground as a front most window or to cause them to be hidden (e.g. minimized) as is known in the art. The dock provided by the Macintosh OS X operating system is an example of such a window control region and is described in published U.S. Application No. 2010/0313164. The Windows XP and Windows 7 operating systems also include a window control region which is referred to as a task bar; this task bar includes a middle section which allows a user to switch quickly between programs and opened windows and allows a user to control which opened windows are shown and which are hidden or minimized.

### SUMMARY OF THE DESCRIPTION

A minimized view of an application can be provided, in one embodiment, from an application control region or window control region. The minimized view of a first application can include controls or commands (e.g. commands such as a play button or command or a pause button or command, etc.) that are available when a first window of the first application is the front most window. The minimized view can be invoked from the window control region and can receive and respond to user inputs on the controls even when a second application's window is the front most window. This can allow a user access to the controls of the first application without changing the order of the windows displayed on the rest of the display device.

A method in one embodiment of the invention includes displaying a window control region on a display device, and the window control region can include a plurality of subregions, each of the subregions being selectable to control a corresponding window, and each subregion can have a control to hide the corresponding window and can have a control to cause the corresponding window to become a foreground or front most window. The window control region can be displayed at an edge of the display device. The method further includes receiving a first input within a first subregion of the plurality of subregions. The first input is configured to cause a display of a minimized view of a first application that is controlling a first window, and the first window is controlled by and corresponds to the first subregion. The minimized view is separate from the first window and includes at least one command or control for the first application that is also available for user interaction when the first window of the first application is the front most window.

In one embodiment, the first application can be a media player which is configured to play at least one of music, video (e.g. a movie or TV show), or speech synthesized from text, such as speech synthesized from an email, or recorded voicemails, such as voicemails left in a voicemail mail box in a voice over IP (VOIP) system. In one embodiment, the minimized view can be displayed in a region on the display device which is next to the subregion which was used to invoke the minimized view. Further, the minimized view can be displayed at the same time that a window of a second application is the front most window, where the first application is different than the second application.

In another embodiment, a method according to the present invention can include displaying, on a display device, an application control region having a plurality of icons, each of the icons being associated with a corresponding application to control the corresponding application. For example, each of the icons can be configured to receive at least one input to launch or to quit the application associated with the icon. The application control region can be displayed at an edge of the display device and can be configured to receive an input to add a new icon into the application control region. This input to add a new icon can be by way of dragging an icon into the application control region or can occur through a system operation when a new application program is installed on the system, which causes a new icon for that new application to be added into the application control region and the new icon can appear in the application control region even if the new application is not executing. The method according to this embodiment can further include receiving a first input within the application control region to cause the display of a minimized view of the first application. The minimized view is separate from a first window of the first application, and the minimized view includes at least a plurality of controls or commands that are also available when the first window is the front most window. Operating any one of the plurality of controls in the minimized view has the same effect on the first application as operating the corresponding control or command in the first window. The minimized view for the first application can be displayed at the same time that a window of a second application is the front most window, and this first application can be different than the second application. A first icon, corresponding to the first application, can be displayed in the application control region along with the second icon, which corresponds to the second application. Each of these icons can be used to quit or to launch or force quit, in one embodiment, each of their respective application programs. Further, each of these icons can be used, in one embodiment, to hide or minimize a corresponding window of the application or to bring one or more windows of the corresponding application to become the front most window.

Various systems and machine readable, tangible, non-transitory storage media and other methods are also described herein.

The above summary does not include an exhaustive list of all aspects of the present invention. It is contemplated that the invention includes all systems and methods that can be practiced from all suitable combinations of the various aspects summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 shows a flow chart which depicts one embodiment of the present invention.

FIG. 2 is a flow chart which illustrates a method according to an embodiment of the present invention.

FIG. 3 is a block diagram illustrating a software architecture which can be used in one embodiment of the present invention.

FIGS. 4A, 4B, 4C, and 4D illustrate a user interface implementing one embodiment of the present invention.

FIGS. 5A, 5B, and 5C show another example of a user interface implementing an embodiment of the present invention.

FIG. 6 shows an example of a user interface for a minimized view for a voicemail application, such as a voicemail application in a VOIP application in a data processing system.

FIG. 7 illustrates a block diagram of an exemplary API architecture which can be used in some embodiments of the invention.

FIG. 8 is an exemplary embodiment of an API architecture which can be used in some embodiments of the present invention.

FIG. 9 is an example of a data processing system that can be used to implement one or more embodiments described herein.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2010.

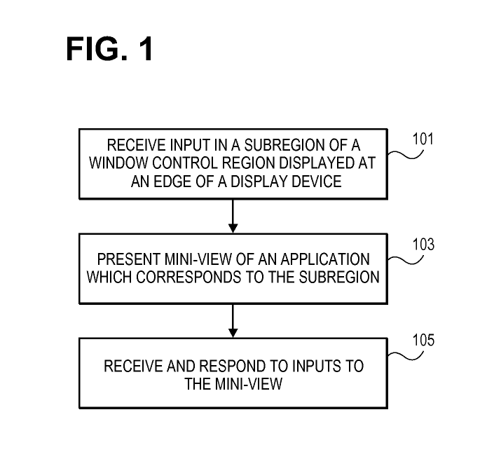

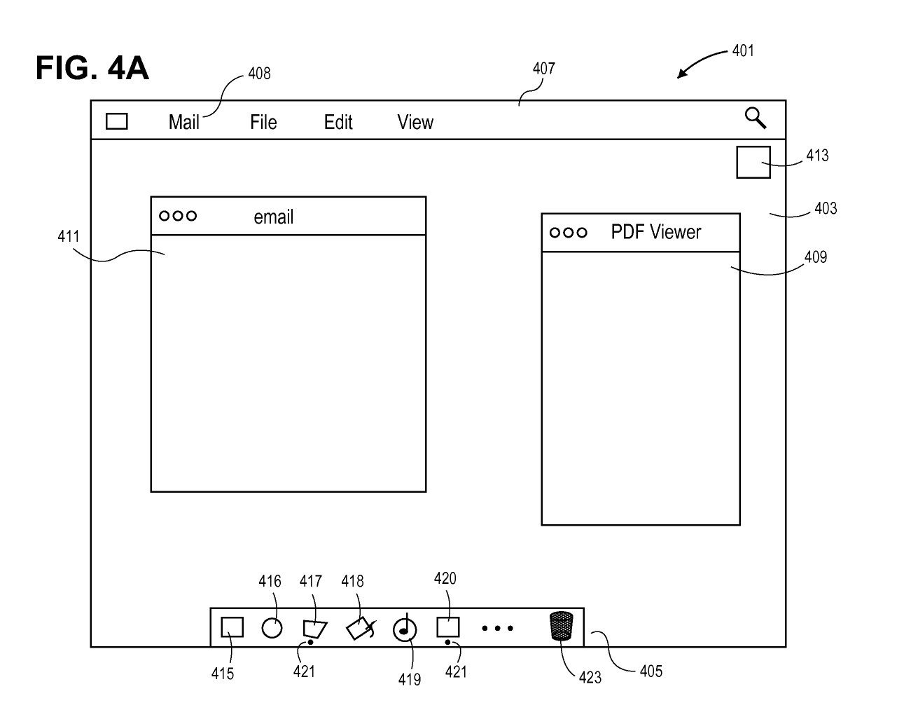

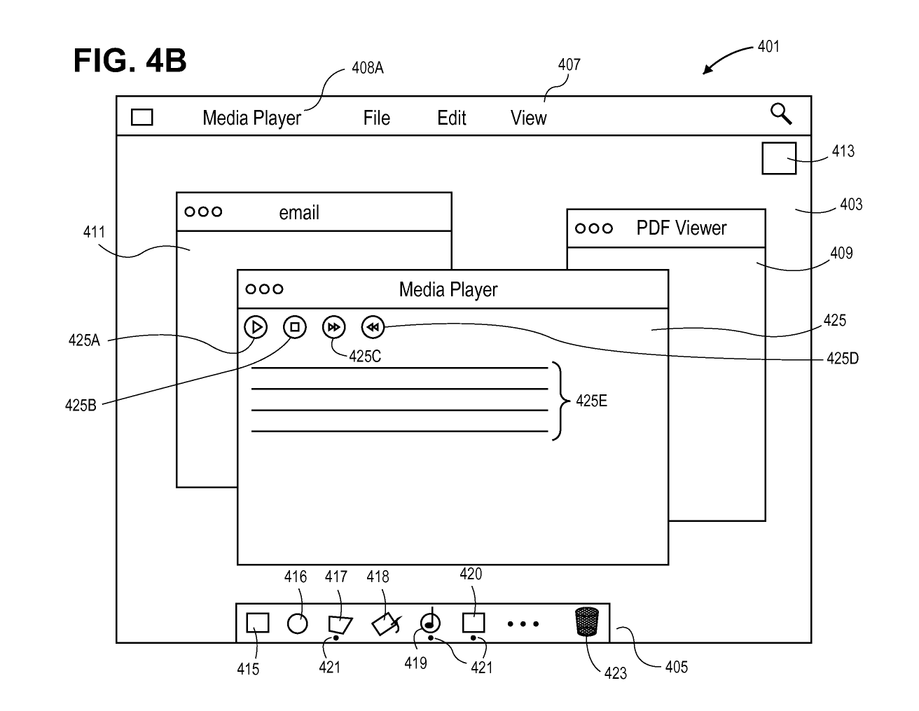

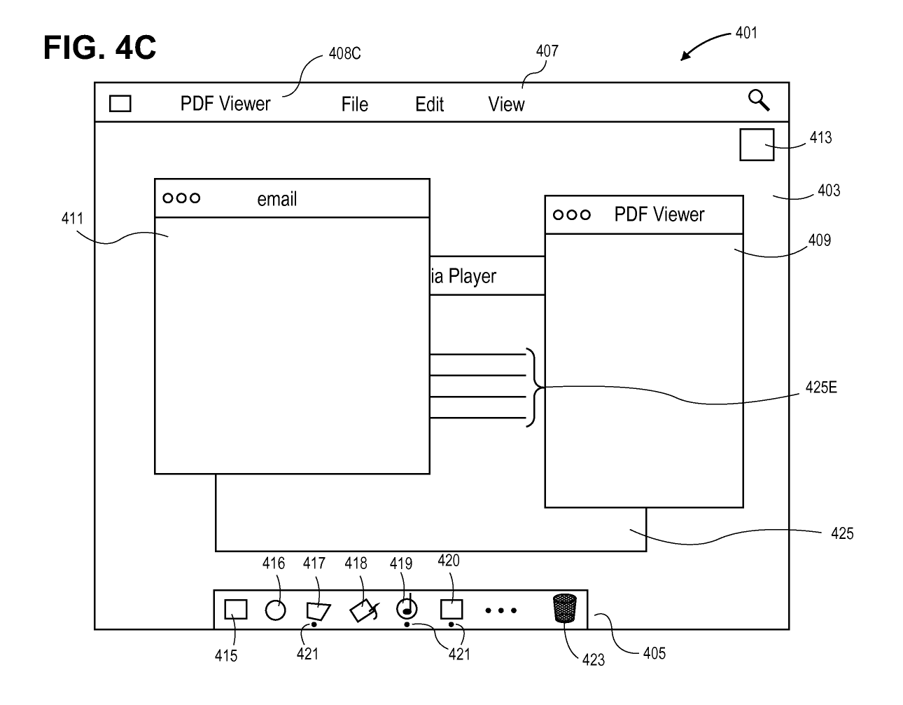

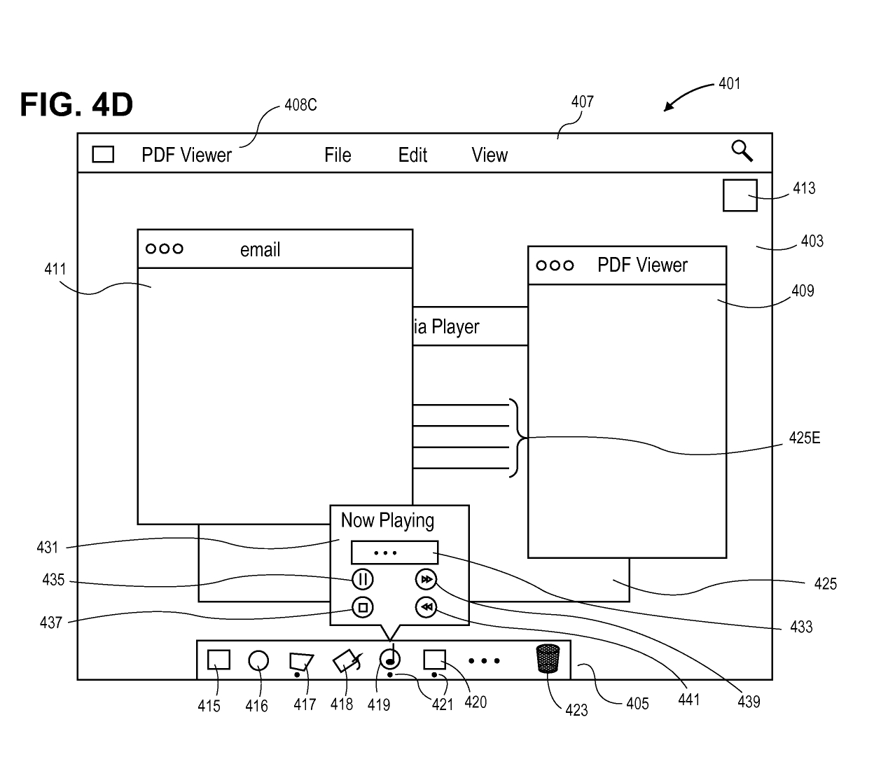

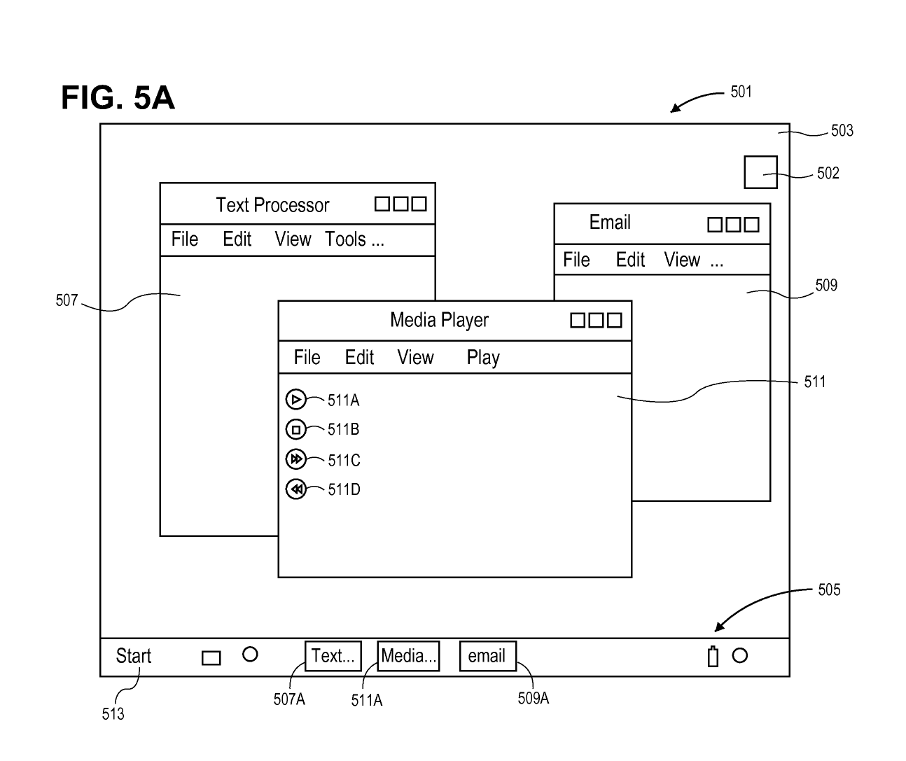

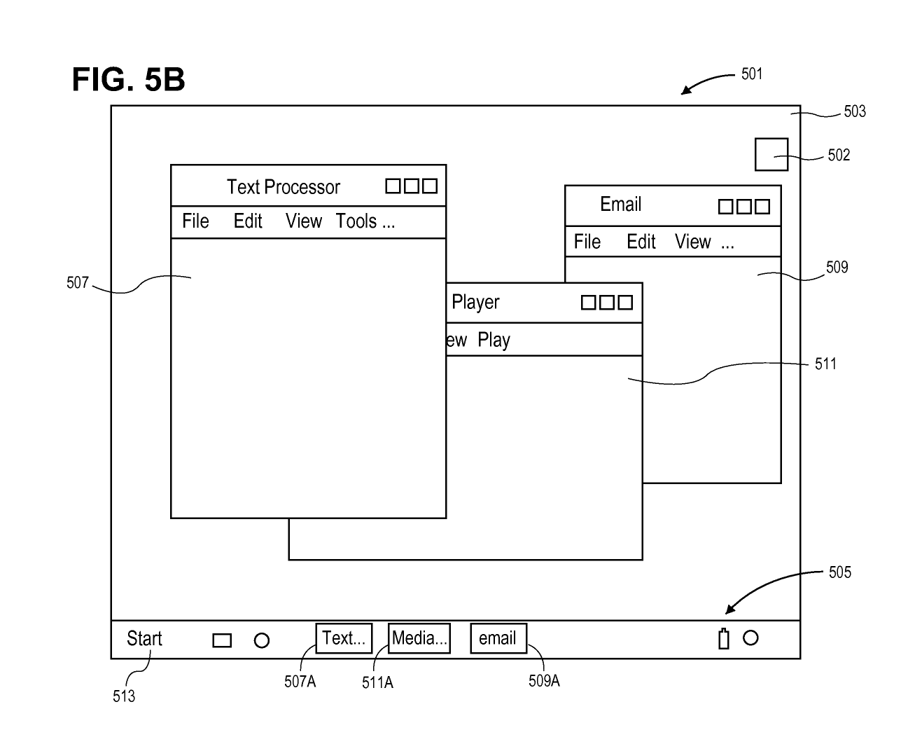

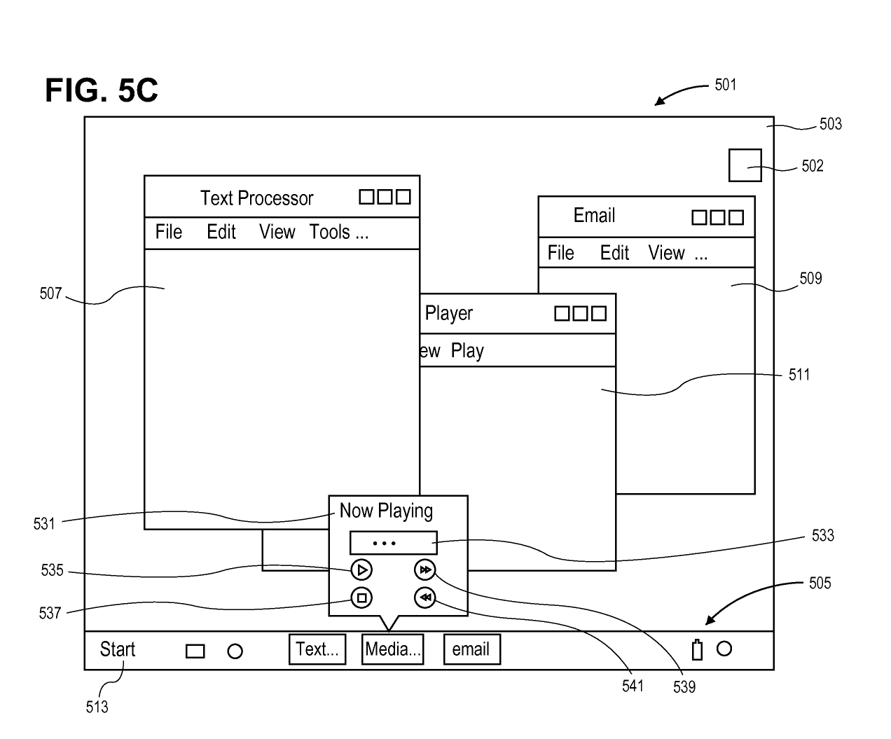

FIG. 1 shows an exemplary method according to one embodiment of the present invention. In this method, a minimized view of an application can be provided from an input applied to a subregion of a window control region which is displayed at an edge of a display device. In operation 101, a system can receive an input in a subregion of a window control region which is displayed at an edge of the display device. The window control region can be the dock 405 shown in FIGS. 4A-4D or can be the window control region 505 shown in FIGS. 5A-5C. The input can be designed to signal a request for the minimized view (“mini-view”), and this input can take a variety of different forms. For example, the input can be the hovering of a cursor, controlled by a cursor control device such as a mouse or a touch screen, over an icon in a subregion in a dock or hovering the cursor over a subregion in a task bar of a system or a gesture with a finger or stylus or a gesture with a data input peripheral such as a mouse or touch screen or touch pad or a selection from a contextual menu obtained from a right-click operation with a cursor and a mouse or a gesture with a finger, etc. In one embodiment, each subregion can correspond to an application which has an opened window for the application. In one embodiment, there can be multiple subregions for an application or only one subregion, with an icon optionally, for each application as in the case of the dock. FIG. 4A shows multiple subregions in dock 405, each of which can include an icon such as icons 415, 416, 417, 418, 419, and 420, and each of which is associated with and corresponds to a particular application. In the embodiment shown in FIG. 5A, subregions 507A, 511A, and 509A correspond to three different software applications which are each concurrently running and displaying at least one window for each of those three applications. Each of these subregions can receive the input described in operation 101 of FIG. 1. Similarly, each of the subregions containing the icons shown in FIG. 4A can also be configured to receive the input shown in operation 101 of FIG. 1.

In response to the input received in operation 101, the system can present (e.g. display) a minimized view of an application which corresponds to the subregion which received the input. In one embodiment, the minimized view can appear next to and attached to the subregion which received the input. Examples of minimized views are shown in FIGS. 4D (which shows minimized view 431) and 5C (which shows minimized view 531). The minimized views can be presented with at least one or more commands which are accessible when the corresponding application's window is the front most window, and use of these commands from within the minimized view has the same action as using the corresponding command within the window of the application when the window is available as the front most window. In one embodiment, the minimized view is separate from the application's window but includes a subset of the commands available for user interaction when a window of this application is the front most window. For example, as can be seen from FIGS. 4B and 4D, the media player application includes a plurality of controls or commands, such as a play button or a pause button or a skip or fast forward button, etc. and at least a subset of those commands is provided in the minimized view 431 for the media player application, even when another application is the front most application and even when the media player's window is opened but obscured by one or more other software applications.

In operation 105, the system can receive and respond to inputs applied by the user to the one or more controls presented in the minimized view. For example, a user can interact with any one of the user interface elements, such as buttons, etc. displayed within a minimized view, and the result of these interactions will be the same as if the user had interacted with the same button shown in a window of that corresponding application. For example, if the user selects stop button 437 from minimized view 431, this will have the same effect as if the user had selected stop button 425B from window 425 when that window was the front most window as shown in FIG. 4B.

In one embodiment, each of the subregions in the window control region can be configured to be able to receive a command to hide a corresponding window or set of windows and can be configured to receive a command to bring a window of the application front most or all of the windows of the application front most in response to a user input. Also, in one embodiment, the window control region can be configurable to disappear when not being used and can be configured to appear in response to a user command at the edge of a display device.

In one embodiment, the input which causes the display of a minimized view of an application is a selection of a first menu item from a menu displayed adjacent to the subregion which received the input in operation 101. This menu can also include a second menu item to hide any windows of the first application and a third menu item to quit the first application. Other menu items may be included in the menu or fewer menu items may be included in this menu. In one embodiment, a second input, which is different than the first input which causes the display of the minimized view, can cause a window of the first application to become a foreground window when the second input is applied to the subregion which received the input in operation 101.

In one embodiment, at least one application is launchable from a corresponding subregion of the plurality of subregions, and additional icons for additional application programs can be added to the window control region in one embodiment.

The minimized view can, in one embodiment, provide controls for a media player application. The media player application can be configured to play at least one of: music; or video (e.g. a movie or TV show, etc.); or speech synthesized from text, such as speech synthesized from the text of an email; or one or more voicemails received in a voicemail application or a VOIP application on a data processing system. The media player can include controls or commands for playing the media or pausing the media or stopping the media or performing a fast forward through a currently selected media item, or performing a fast reverse through the media or include a control or command to skip to the next item in the media or to skip to the prior media item in a list of media items.

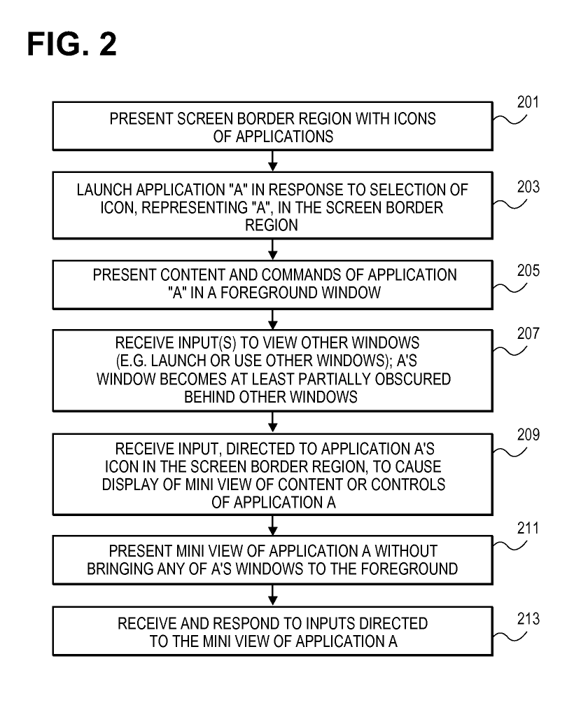

FIG. 2 shows a method according to an embodiment of the present invention. FIG. 2 can be implemented with the user interface shown in FIGS. 4A, 4B, 4C, and 4D. These user interfaces may be controlled with a cursor control device, such as a mouse, which controls a cursor or may be controlled through a touch input system such as through a touch screen or touch pad, and the touch input could be from a finger or a plurality of fingers of the user or from a stylus controlled by a user. Dock 405 shown in FIGS. 4A, 4B, 4C, and 4D is an example of a window control region or application control region which is displayed at an edge of a display screen of a display device, such as a liquid crystal display (LCD). In one embodiment, dock 405 can be provided by the Macintosh OS X operating system or other operating systems known in the art.

The user interface shown in FIGS. 4A, 4B, 4C, and 4D include a display screen or display device 401 which presents a desktop 403, which is known in the art, and a menu bar 407, which is known in the art. The user interface further presents one or more windows, such as PDF viewer window 409 and email window 411. Each of these windows can include a title bar which can display the name of the application or the name of a document or file presented by the application. The title bar can also include conventional user interface elements, such as the three circles shown in the title bar of email window 411 and the three circles shown in the title bar of the PDF viewer window 409. These user interface elements can be used, as is known in the art, to close a window, or to minimize the window, or to maximize a window. Desktop 403 can also include one or more icons which have been placed on the desktop by the system or by the user. In the embodiment shown in FIGS. 4A-4D, a storage icon 413 is displayed on desktop 403, and this storage icon can represent a storage device such as a hard drive or other mass storage device containing files of the user. Menu bar 407 displays an application menu 408 which is for the email program known as Mail, and this indicates that a window of the email program is the front most window and hence the email application is the front most application. This means that the context of the system is set up such that a user input, such as a keyboard input or text input or cursor input or finger input will be applied to the front most application if the input is applied within a region designated for that application, such as within email window 411 or any one of the menu items of the email program in menu bar 407 as is known in the art.

The user interface shown in FIGS. 4A-4D also includes dock 405 which can be configured to be displayed, in one embodiment, at the bottom edge or the left edge or the right edge of a display device as is known in the art. The dock can include a plurality of icons, each of which can be used to launch a corresponding application or to quit a corresponding application or to force quit a corresponding application or to bring windows previously opened to the foreground or to hide (e.g. minimize) previously opened windows of the application. Furthermore, in one embodiment, additional icons for additional applications, such as newly added software applications that have been newly installed on the data processing system, can be added to the dock through either a drag and drop operation by dragging an icon from a window onto the dock or automatically the by the system through a software installation process as is known in the art. Moreover, in certain embodiments, the dock can be hidden from view and not displayed on a display device until a user positions a cursor near an edge of the display device where the dock is to be displayed or performs some other input or action to cause the dock to be displayed as is known in the art. In the example shown in FIGS. 4A-4D, the dock 405 includes a file system manager icon 415, a web browser icon 416, a PDF viewer application icon 417, a text editor icon 418, a media player icon 419, and an email icon 420. In some embodiments, the dock 405 can also include a trash can icon 423 which can be configured to receive and display icons of files which are to be deleted. Dock 405, in one embodiment, can also include an indicator, such as active indicator 421, which indicates that the corresponding application is currently executing on the system. In the example shown in FIG. 4A, the PDF viewer application is executing and presenting PDF viewer window 409 and hence active indicator 421 appears below PDF viewer application icon 417. Similarly, the email application is currently executing as the front most application, and this is indicated by the active indicator 421 below email icon 420.

Referring back to FIG. 2, operation 201 involves presenting (e.g. displaying) a screen border region with icons of applications. In one embodiment, the screen border region can be dock 405 as shown in FIGS. 4A-4D. In operation 203, the data processing system can launch application A in response to a selection of an icon which represents application A and which is displayed in the screen border region. In the example shown in FIGS. 4A-4D, a user can select media player icon 419 to cause it to be launched, which in turn causes the media player application to present media player window 425 as shown in FIG. 4B. It can be seen from FIG. 4B that the media player application has now become the front most application with the media player window 425 being the front most window and partially obscuring email window 411 and PDF viewer window 409. This can also be seen from menu bar 407 in which the menu application is now menu application 408A showing that the media player as the front most application. In this case, keyboard inputs such as an up button or a down button on the keyboard, when pressed, will cause, in one embodiment, a scrolling operation or a movement of a currently selected item such as any one of the song titles or other items displayed within media player window 425. In the example shown in FIG. 4B, media player window 425 displays a list of media 425E which could be a list of songs, or a list of videos, or a list of TV shows, or a list of movies, etc. In addition, media player window 425 includes a plurality of controls or commands which can be used to control playback of any one of the media items or to perform other operations. In the example shown in FIG. 4B, media player window 425 includes a play button 425A, a stop button 425B, a “skip to next” media item button 425C, and a “skip to prior” media item button 425D. In one embodiment, the play button 425A can change between a play button and a pause button as is known in the art. When, in one embodiment, the pause button is displayed, the media is playing and activating that pause button will pause the playing of the media; when the play button is displayed as shown in FIG. 4B, activating that button will cause the currently selected media item to be played. In one embodiment, the media player can be the iTunes software application from Apple Inc. of Cupertino, Calif.

The presentation of the user interface of the media player application is an example of operation 205 in FIG. 2 in which content of the media player is presented along with commands of the application in a foreground window. It will be appreciated that the commands could also be in the pull down menus activated from menu bar 407, and these commands in the pull down menus can also appear in the minimized view of the application.

Referring back to FIG. 2, in operation 207, the system receives one or more inputs to view other windows. For example, the system can receive a request to use other windows or interact with other windows or to launch another application. As a result, windows of application A can become obscured by being at least partially obscured behind other windows. An example of the result of operation 207 is shown in FIG. 4C in which a user has transitioned from using the media player application to using the PDF viewer which has now become the front most application as indicated by the application menu 408C. Prior to causing the PDF viewer application to be the front most window, the user had also interacted with the email application causing email window 411 to partially obscure media player window 425. As a result, a substantial portion of the media player window 425 is now obscured by email window 411 and PDF viewer window 409; in fact, the four buttons or controls 425A-425D are now obscured in the view shown in FIG. 4C. At this point, in the prior art, if the user wanted to change a song selection in the media player or to stop playback or to otherwise interact with the media player, the user needed to bring the media player application front most to cause its window 425 to appear front most and then be able to interact with one or more of the controls in the media player window or in the pull down menus in the menu bar 407. However, with at least one embodiment of the present invention, the user can interact with at least a subset of those controls by invoking a minimized view of the application, such as the media player application.

Referring back to FIG. 2, in operation 209, the system receives an input, directed to application A's icon in the screen border region, and this input is configured to cause the display of a minimized view of content and/or commands or controls of application A. In response to this input, the system presents, in operation 211, a minimized view of application A without bringing any of Application A's windows to the foreground. Then the system, in operation 213, can receive and respond to inputs directed to the minimized view of application A. Operation 209 can occur from the view shown in FIG. 4C in which the media player window is partially obscured by email window 411 and PDF viewer window 409. The input can be applied to icon 419 by, for example, hovering the cursor over that icon in dock 405 or by a gesture with a cursor or finger or stylus relative to that icon or a selection from a contextual menu generated by right-clicking icon 419 or by providing some other input to cause the presentation of a contextual menu for icon 419. Other inputs could also be used to cause the presentation of a minimized view, such as a voice command in a speech recognition system, etc. In response to this command, the system presents, as shown in FIG. 4D, a minimized view 431 of the media player application. In one embodiment, the minimized view, such as minimized view 431, can be presented as being attached to the region or subregion of dock 405 which contains application A's icon (in this case media player icon 419). In one embodiment, the minimized view 431 can appear to be pointing to that icon 419 as shown in FIG. 4D. The minimized view can include content of its application, such as a song name or a playing time or a picture of the currently playing song derived from album art for the song, etc. In addition, the minimized view 431 includes at least a subset of the controls or commands available from the media player window 425. These controls have the same effect as the controls within media player window 425. For example, the pause or play button 435 can have the same effect as play button 425, and the stop button 437 can have the same effect (of stopping playback) as stop button 425B. Similarly, the skip next or forward button 429 and the skip backward button 441 can have the same effect as buttons 425C and 425D when they are activated, respectively. Hence, the user can control playback of the currently selected song and can also see content of that song within content field 433 from the minimized view 431 without making the media player application the front most application. Hence, the minimized view 431 can be displayed at the same time that a window of another application, such as PDF viewer window 409, is the front most application and has the front most window and also at the same time that a window of the media player is also displayed. Hence, rather than making the media player window the front most window, the user can stop playback by activating button or selecting button 437 or can pause playback or cause playback to start by selecting button 435 or can skip to the next song or media by pressing button 439 or can skip back to a prior media item by selecting or pressing button 441.

As noted previously, the media items can be displayed in a list such as the list of items 425E, and the media can include any one or more of music, video (e.g. a TV show or movie, etc.), or speech synthesized from text content or a recorded voicemail from a voicemail system in a voice over IP (VOIP) system. In one embodiment, the minimized view can include a close button (not shown in minimized view 431) which a user can interact with in order to close the minimized view; alternatively, the minimized view, such as minimized view 431, can close automatically in response to moving a cursor off of the icon 419 or out of the minimized view 431; alternative mechanisms for closing or removing minimized view 431 can include a speech command, in one embodiment, using a speech recognition system, and other methods could also be employed.

In one embodiment of the user interface shown in FIGS. 4A-4D, icons on the dock can also be used to perform any one of the currently available operations which exist in the dock provided by the Macintosh OS X operating system including, for example, the ability to minimize windows of an application or bring the windows of an application to the foreground or to force quit or quit an application or to launch an application, etc. These various different options can be implemented using different inputs or different gestures or can be implemented through a selection of different menu items in a menu presented as a result of a specific input, such as a right-click or a finger gesture relative to the particular icon on the dock.

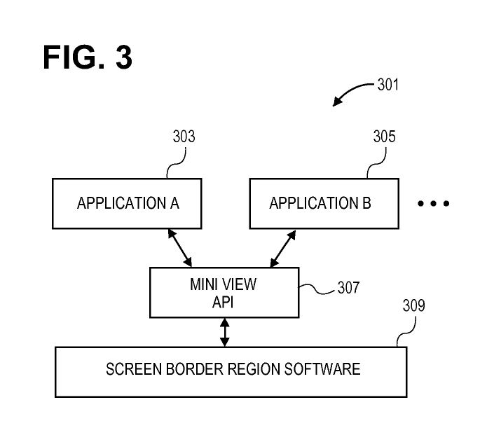

In one embodiment, a minimized view can be made available to each and every application on a system by providing a minimized view API which can interact with the software that controls the screen border region, such as the software that controls dock 405. In this way, each application can specify the various controls it wants presented within its minimized view and can receive responses to selection or activation of those controls from within the minimized view. FIG. 3 represents an example of a software architecture in which a minimized view API 307 is used to communicate between each of the various applications that want to provide a minimized view and a screen border region software 309 which controls, for example, dock 405 or window control region 505 in the example shown in FIGS. 5A-5C. Application A 303 and application B 305 can each separately communicate through the minimized view API 307 with the screen border region software 309 to implement the respective, and potentially different, minimized views, each with controls that are appropriate for the particular application. This architecture can allow the concurrent display and use of multiple minimized views for multiple applications.

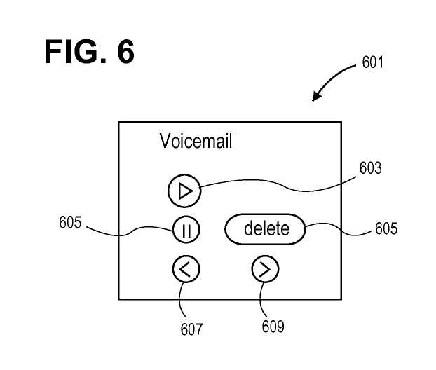

FIG. 6 provides an example of a minimized window 601 for a voicemail system for a VOIP software application executing on a data processing system. The controls within minimized view 601 can differ from those controls provided in minimized window 531 and minimized window 431 and can be dictated by the particular application through the minimized view API 307. In the example shown in FIG. 6, the minimized view 601 includes a play button 603, a pause button 605, a skip backward button 607 which is used to skip to the prior voicemail from the currently selected voicemail, and a skip forward button 609 which is used to skip to the next voicemail from the currently selected voicemail in the list of voicemails. Another window (not shown) can be a main window of the voicemail system and can be considered a visual voicemail application. An example of a visual voicemail application is provided in published U.S. Application No. 2008/0167007, which application is incorporated herein by reference. As a user listens to each of the voicemails, the user can select the current voicemail for deletion by activating button 605 shown in the minimized view 601 rather than having to access a separate visual voicemail window and make it a foreground window in the visual voicemail application. These operations can be performed through the API 307 as shown in FIG. 3.

The minimized view shown in FIG. 6 can also display content of the voicemail, such as a time/date of a currently playing voicemail or an identification of the caller who left the voicemail, etc.

FIGS. 5A-5C present an alternative user interface which can employ a minimized view from subregions of window control region 505 which, in one embodiment, can be the task bar of a Windows operating system. In particular, subregions 507A, 511A and 509A could be the subregions which appear within the middle portion of the task bar in the Windows operating system and can be used to control whether a window is a foreground window or a background window and whether the window is hidden or minimized, as is known in the art. The user interface shown in FIG. 5A, FIG. 5B, and FIG. 5C is presented on a display device 501 and includes a desktop 503 and the window control region 505. In addition, one or more icons can be presented on the desktop, such as the storage or computer icon 502 and a plurality of windows can also be presented on the desktop 503. In the example shown in FIG. 5A, the media playing application is the front most application and hence will receive keyboard inputs. In other words, the keyboard focus is on this front most window and application. The media player application has a front most window which is window 511 which partially obscures a text processor application's window 507 and an email window 509 presented by an email application. The window control region 505 includes three subregions which correspond to the three opened applications. In particular, subregion 507A corresponds to a text processor application and controls whether or not text processor window 507 is a foreground window or is minimized, etc. as is known in the art. Similarly, subregion 511A controls whether media player window 511 is a foreground window or is minimized as is known in the art. Similarly, subregion 509A can control whether window 509 is a foreground window or is minimized as is known in the art. Each of these subregions corresponds to a particular window or application. Window control region 505 can also include one or more icons which can launch applications or which can invoke utilities. Furthermore, window control region 505 can include a start menu 513 as is known in the art.

In the example shown in FIG. 5A, the user has caused the media player application to be the front most application and its window 511 is the front most window. This window includes four buttons or controls 511A-511D for controlling playback of media. For example, a user can cause playback of the currently selected media item by selecting or interacting with button 511A, and similarly the user can stop playback by selecting button 511B. Moreover, the user can skip to the next media item in a list of items by selecting button 511C, and a user can go back in the list to the prior media item from the current media item by selecting button 511D. These selections can be performed when the media player window 511 is the foreground window. However, as shown in FIG. 5B, when that window 511 becomes obscured by the text processor window 507 because the user is now interacting with the text processor, it is no longer possible for the user to activate controls within window 511 without making the window 511 the foreground window. However, with an embodiment of the present invention, the user can, through an input to subregion 511A, cause the presentation of a minimized view 531 which is a minimized view of the media player application which includes content window 533 showing content, such as the name of a song or movie, and four buttons to control playback. In particular, minimized view 531 includes a play button 535 which may toggle between a play button and a pause button depending on the state of the playback of the currently selected media item as is known in the art. Further, minimized view 531 can include a stop button 537 and a skip forward button 539 and a skip back button 451 which cause the same actions, when selected, as buttons 511D, 511C, and 511B, respectively.

Hence, a user can allow a particular application window to remain in the background, obscured by other windows, as shown in FIG. 5C and still be able to interact with controls that are available only from that application's main window when it is the foreground window, such as in FIG. 5A where the media player window 511 is the foreground window.

Some embodiments include one or more application programming interfaces (APIs) in an environment with calling program code interacting with other program code being called through the one or more interfaces. Various function calls, messages or other types of invocations, which further may include various kinds of parameters, can be transferred via the APIs between the calling program and the code being called. In addition, an API may provide the calling program code the ability to use data types or classes defined in the API and implemented in the called program code.

At least certain embodiments include an environment with a calling software component interacting with a called software component through an API. A method for operating through an API in this environment includes transferring one or more function calls, messages, other types of invocations or parameters via the API.

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

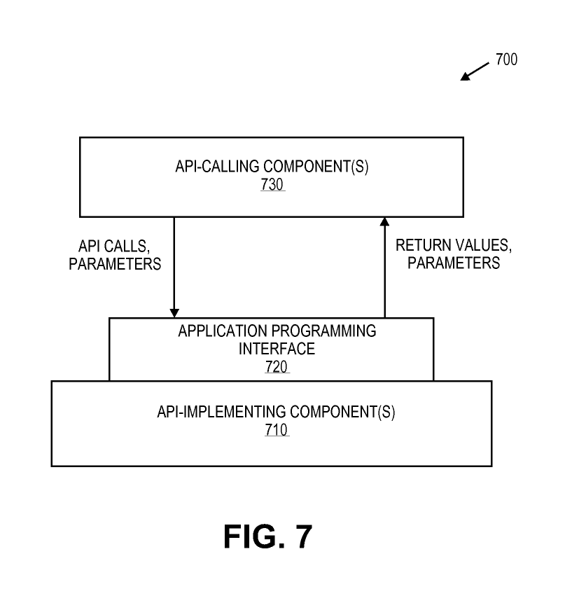

FIG. 7 is a block diagram illustrating an exemplary API architecture, which may be used in some embodiments of the invention. As shown in FIG. 7, the API architecture 700 includes the API-implementing component 710 (e.g., an operating system, a library, a device driver, an API, an application program, software or other module) that implements the API 720. The API 720 specifies one or more functions, methods, classes, objects, protocols, data structures, formats and/or other features of the API-implementing component that may be used by the API-calling component 730. The API 720 can specify at least one calling convention that specifies how a function in the API-implementing component receives parameters from the API-calling component and how the function returns a result to the API-calling component. The API-calling component 730 (e.g., an operating system, a library, a device driver, an API, an application program, software or other module), makes API calls through the API 720 to access and use the features of the API-implementing component 710 that are specified by the API 720. The API-implementing component 710 may return a value through the API 720 to the API-calling component 730 in response to an API call.

It will be appreciated that the API-implementing component 710 may include additional functions, methods, classes, data structures, and/or other features that are not specified through the API 720 and are not available to the API-calling component 730. It should be understood that the API-calling component 730 may be on the same system as the API-implementing component 710 or may be located remotely and accesses the API-implementing component 710 using the API 720 over a network. While FIG. 7 illustrates a single API-calling component 730 interacting with the API 720, it should be understood that other API-calling components, which may be written in different languages (or the same language) than the API-calling component 730, may use the API 720.

The API-implementing component 710, the API 720, and the API-calling component 730 may be stored in a tangible machine-readable storage medium, which includes any mechanism for storing information in a form readable by a machine (e.g., a computer or other data processing system). For example, a tangible machine-readable storage medium includes magnetic disks, optical disks, random access memory (e.g. DRAM); read only memory, flash memory devices, etc.

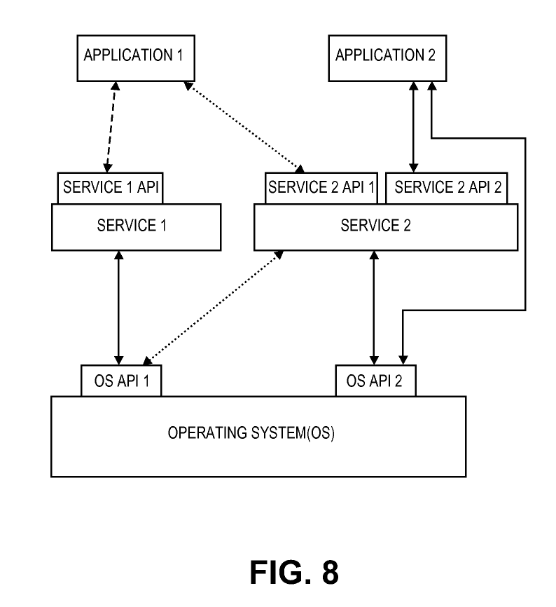

In FIG. 8 (“Software Stack”), an exemplary embodiment, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

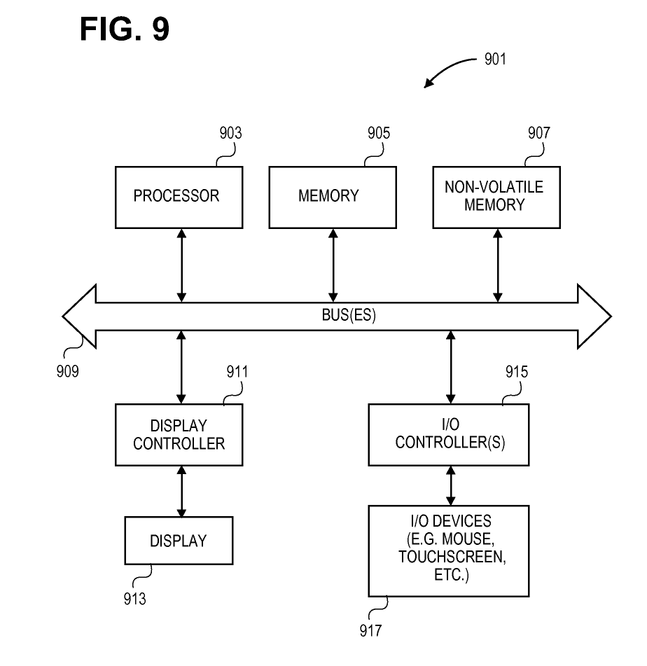

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device. FIG. 9 shows one example of a typical data processing system which may be used with the present invention. Note that while FIG. 9 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 9 may also be used with the present invention. The data processing system of FIG. 9 may be a Macintosh computer from Apple Inc. of Cupertino, Calif. As shown in FIG. 9, the data processing system 901 includes one or more buses 909 which serve to interconnect the various components of the system. One or more processors 903 are coupled to the one or more buses 909 as is known in the art. Memory 905 may be DRAM or non-volatile RAM or may be flash memory or other types of memory. This memory is coupled to the one or more buses 909 using techniques known in the art. The data processing system 901 can also include non-volatile memory 907 which may be a hard disk drive or a flash memory or a magnetic optical drive or magnetic memory or an optical drive or other types of memory systems which maintain data even after power is removed from the system. The non-volatile memory 907 and the memory 905 are both coupled to the one or more buses 909 using known interfaces and connection techniques. A display controller 911 is coupled to the one or more buses 909 in order to receive display data to be displayed on a display device 913 which can display any one of the user interface features or embodiments described herein. The display device 913 can include an integrated touch input to provide a touch screen. The data processing system 901 can also include one or more input/output (I/O) controllers 915 which provide interfaces for one or more I/O devices, such as one or more mice, touch screens, touch pads, joysticks, and other input devices including those known in the art and output devices (e.g. speakers). The input/output devices 917 are coupled through one or more I/O controllers 915 as is known in the art. While FIG. 9 shows that the non-volatile memory 907 and the memory 905 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers. As is known in the art, the one or more buses 909 may include one or more bridges or controllers or adapters to interconnect between various buses. In one embodiment, the I/O controller 915 includes a USB adapter for controlling USB peripherals and can control an Ethernet port or a wireless transceiver or combination of wireless transceivers. It will be apparent from this description that aspects of the present invention may be embodied, at least in part, in software. That is, the techniques and methods described herein may be carried out in a data processing system in response to its processor executing a sequence of instructions contained in a memory such as the memory 905 or the non-volatile memory 907 or a combination of such memories and each of these memories is a form of a machine readable, tangible non-transitory storage medium. In various embodiments, hardwired circuitry may be used in combination with software instructions to implement the present invention. Thus the techniques are not limited to any specific combination of hardware circuitry and software nor to any particular source for the instructions executed by the data processing system.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method comprising:
displaying a window control region on a display device, the window control region having a plurality of subregions, each of the subregions being selectable to control a corresponding window, each subregion having a control to hide the corresponding window and having a control to cause the corresponding window to become a foreground window, the window control region being displayed at an edge of the display device;
receiving a first input within a first subregion of the plurality of subregions, the first input configured to cause a display of a minimized view of a first application that is also controlling a first window, the first window being controlled by and corresponding to the first subregion, wherein the minimized view is separate from the first window and includes at least one command for the first application that is also available for user interaction when the first window of the first application is the front most window.

2. The method as in claim 1 wherein the window control region is configurable to disappear when not being used and is configured to appear in response to a user command at the edge of the display device and wherein the minimized view is displayed attached to the window control region next to the first subregion.

3. The method as in claim 1 wherein the first input, which causes the display of the minimized view, is a selection of a first menu item from a menu displayed adjacent to the first subregion and invoked from the first subregion, and wherein the menu comprises a second menu item to hide any windows of the first application and a third menu item to quit the first application.

4. The method as in claim 3 wherein a second input, when applied to the first subregion, causes a window of the first application to become a foreground window and wherein the minimized view comprises a plurality of commands to control the first application.

5. The method as in claim 4 wherein at least one application is launchable from a corresponding subregion of the plurality of subregions and wherein the plurality of commands comprise a first command to play media and a second command to stop or pause playback of media and wherein the minimized view is displayed next to and attached to the first subregion in the window control region.

6. The method as in claim 5 wherein the media is one of (a) music; (b) video; (c) speech synthesized from text; or (d) a voicemail.

7. The method as in claim 1 wherein the minimized view is displayed at the same time that a window of a second application is the front most window, wherein the first application is different than the second application.

8. The method as in claim 6 wherein the minimized view is displayed at the same time that a window of a second application is the front most window, wherein the first application is different than the second application.

9. A machine readable, tangible, non-transitory storage medium storing executable instructions, which when executed cause a data processing system to perform a method comprising:
displaying a window control region on a display device, the window control region having a plurality of subregions, each of the subregions being selectable to control a corresponding window, each subregion having a control to hide the corresponding window and having a control to cause the corresponding window to become a foreground window, the window control region being displayed at an edge of the display device;
receiving a first input within a first subregion of the plurality of subregions, the first input configured to cause a display of a minimized view of a first application that is also controlling a first window, the first window being controlled by and corresponding to the first subregion, wherein the minimized view is separate from the first window and includes a least one command for the first application that is also available for user interaction when the first window of the first application is the front most window.

10. The medium as in claim 9 wherein the window control region is configurable to disappear when not being used and is configured to appear in response to a user command at the edge of the display device and wherein the minimized view is displayed attached to the window control region next to the first subregion.

11. The medium as in claim 9 wherein the first input, which causes the display of the minimized view, is a selection of a first menu item from a menu displayed adjacent to the first subregion and invoked from the first subregion, and wherein the menu comprises a second menu item to hide any windows of the first application and a third menu item to quit the first application.

12. The medium as in claim 11 wherein a second input, when applied to the first subregion, causes a window of the first application to become a foreground window and wherein the minimized view comprises a plurality of commands to control the first application.

13. The medium as in claim 12 wherein at least one application is launchable from a corresponding subregion of the plurality of subregions and wherein the plurality of commands comprise a first command to play media and a second command to stop or pause playback of media, and wherein the minimized view is displayed next to and attached to the first subregion in the window control region.

14. The medium as in claim 13 wherein the medium is one of (a) music; (b) video; (c) speech synthesized from text; or (d) a voicemail.

15. The medium as in claim 9 wherein the minimized view is displayed at the same time that a window of a second application is the front most window, wherein the first application is different than the second application.

16. The medium as in claim 14 wherein the minimized view is displayed at the same time that a window of a second application is the front most window, wherein the first application is different than the second application.

17. A machine implemented method comprising:
displaying, on a display device, an application control region having a plurality of icons, each of the icons being associated with a corresponding application to control the corresponding application, and each of the icons being configured to receive at least one input to launch or quit the application associated with the icon, and wherein the application control region is displayed at an edge of the display device, and wherein the application control region is configured to accept an input to add a new icon into the application control region;
receiving a first input within the application control region to cause a display of a minimized view of a first application, wherein the minimized view is separate from a first window of the first application and the minimized view includes at least a plurality of controls that are also available when the first window is the front most window and wherein operating any one of the plurality of controls in the minimized view has the same effect on the first application as operating the corresponding control in the first window.

18. The method as in claim 17 wherein the minimized view is displayed at the same time that a window of a second application is the front most window, wherein the first application is different than the second application and wherein a first icon, corresponding to the first application, is displayed in the application control region and a second icon, corresponding to the second application, is also displayed in the application control region, and wherein the first input is applied to the first icon and wherein a second input, when applied to the first icon, causes a window of the first application to become the front most window and wherein a third input, when applied to the first icon, hides at least one window of the first application and wherein the minimized view is displayed next to the first icon.

19. The method as in claim 18 wherein the application control region is configurable to disappear when not being used and is configured to appear in response to a user command applied at the edge of the display device and wherein the plurality of controls comprise a first command to play media and a second command to stop or pause playback of media and wherein the media is one of (a) music; (b) video; (c) speech synthesized from text content in a text or email message; or (d) a voicemail.

20. A machine readable, tangible, non-transitory storage medium storing executable instructions, which when executed cause a data processing system to perform a method comprising:
displaying, on a display device, an application control region having a plurality of icons, each of the icons being associated with a corresponding application to control the corresponding application, and each of the icons being configured to receive at least one input to launch or quit the application associated with the icon, and wherein the application control region is displayed at an edge of the display device, and wherein the application control region is configured to accept an input to add a new icon into the application control region;
receiving a first input within the application control region to cause a display of a minimized view of a first application, wherein the minimized view is separate from a first window of the first application and the minimized view includes at least a plurality of controls that are also available when the first window is the front most window and wherein operating any one of the plurality of controls in the minimized view has the same effect on the first application as operating the corresponding control in the first window.

21. The medium as in claim 20 wherein the minimized view is displayed at the same time that a window of a second application is the front most window, wherein the first application is different than the second application and wherein a first icon, corresponding to the first application, is displayed in the application control region and a second icon, corresponding to the second application, is also displayed in the application control region, and wherein the first input is applied to the first icon and wherein a second input, when applied to the first icon, causes a window of the first application to become the front most window and wherein a third input, when applied to the first icon, hides at least one window of the first application and wherein the minimized view is displayed next to the first icon.

22. The medium as in claim 21 wherein the application control region is configurable to disappear when not being used and is configured to appear in response to a user command applied at the edge of the display device and wherein the plurality of controls comprise a first command to play media and a second command to stop or pause playback of media and wherein the media is one of (a) music; (b) video; (c) speech synthesized from text content in a text or email message; or (d) a voicemail.

23. A data processing system comprising:
means for displaying, on a display device, an application control region having a plurality of icons, each of the icons being associated with a corresponding application to control the corresponding application, and each of the icons being configured to receive at least one input to launch or quit the application associated with the icon, and wherein the application control region is displayed at an edge of the display device, and wherein the application control region is configured to accept an input to add a new icon into the application control region;
means for receiving a first input within the application control region to cause a display of a minimized view of a first application, wherein the minimized view is separate from a first window of the first application and the minimized view includes at least a plurality of controls that are also available when the first window is the front most window and wherein operating any one of the plurality of controls in the minimized view has the same effect on the first application as operating the corresponding control in the first window.

24. The system as in claim 23 wherein the minimized view is displayed at the same time that a window of a second application is the front most window, wherein the first application is different than the second application and wherein a first icon, corresponding to the first application, is displayed in the application control region and a second icon, corresponding to the second application, is also displayed in the application control region, and wherein the first input is applied to the first icon and wherein a second input, when applied to the first icon, causes a window of the first application to become the front most window and wherein a third input, when applied to the first icon, hides at least one window of the first application and wherein the minimized view is displayed next to the first icon.

25. The system as in claim 24 wherein the application control region is configurable to disappear when not being used and is configured to appear in response to a user command applied at the edge of the display device and wherein the plurality of controls comprise a first command to play media and a second command to stop or pause playback of media and wherein the media is one of (a) music; (b) video; (c) speech synthesized from text content in a text or email message; or (d) a voicemail.
